(19) United States
(12) Patent Application Publication
(10) Pub. No.: US 2008/0069684 A1
(43) Pub. Date: Mar. 20, 2008

(54) Gondola for a Wind Energy System; Rotative Connection for a Wind Energy System; Wind Energy System; Method for Operating a Wind Energy System

(76) Inventor: Marcus Ihle, Hamburg (DE)

Correspondence Address: JORDAN AND HAMBURG LLP, 122 EAST 42ND STREET, SUITE 4000, NEW YORK, NY, 10168, US

(21) Appl. No.: 11/663,361

(22) PCT Filed: Sep. 6, 2005
(86) PCT No.: PCT/DE05/01555

§ 371 Date: Nov. 26, 2007

(30) Foreign Application Priority Data
Sep. 21, 2004 (DE) 10 2004 046 029.9
Dec. 10, 2004 (DE) 10 2004 062 360.0
Apr. 18, 2005 (DE) 10 2005 018 290.9

(51) Int. Cl. F03D 1/00

(52) U.S. Cl. 415/4.5

(57) ABSTRACT

The invention relates to gondolas for a wind energy system (WEA), a rotative connection for a wind energy system, a wind energy system and a method for operating a wind energy system, wherein universally applicable components are used, said components being easily interchangable and/or easy to produce everywhere, irrespective of the type of wind energy system, such that, for instance, they can be replaced within established replacement intervals at low cost in order to keep down times of the inventive wind power system to a minimum, such that the yield of the inventive wind system can be optimized as a result of increased technical availability.

### BACKGROUND OF THE INVENTION

The invention relates to a nacelle for a wind-energy installation, a revolving connection for a wind-energy installation, a wind-energy installation and a method for operating a wind-energy installation.

The development of the utilization of wind energy onshore had its beginnings about 20 years ago. Since then, wind energy installations, which usually comprise a tower and nacelle, which is mounted on the tower so that it can be rotated about a vertical axis by means of a wind direction tracking bearing (usually a single or double row ball bearing slewing ring) about a vertical axis, the nacelle having a rotor hub, which is provided with at least one rotor blade that is mounted horizontally rotatable about the rotor hub, has been developed further without interruption with respect to the loads that arise, their dissipation into the tower and manufacturing objectives. One such wind energy installation is described in the Offenlegungsschrift DE 198 14 629 A1.

Environmental and surrounding conditions in the area of use also play an increasing role in the development of wind energy installations, since some time ago the area of use of wind energy installations has also been extended to maritime areas (offshore) and, for the development of the offshore technology required for this purpose, the climate, sea bed shifts, waves, salt and emergency rescues at sea also have to be taken into consideration. For example, the Offenlegungsschrift DE 101 17 113 A1 describes a bearing construction for an offshore wind energy installation tower, which is constructed as a truss construction and, to reduce wave pressure, is inserted between the foundation, set in the floor of the ocean, and the tower head. In addition to the maritime requirements, there is the additional requirement that, for economic reasons, only wind energy installations of large output capacity (so-called multi-megawatt class) come into consideration for the utilization of the wind potential in maritime areas. Accordingly, a state of the art has developed, in which there is hardly any experience with offshore wind energy installations and only prototype experience in the multi-megawatt area. From the point of view of the insurance companies, there are problems with offshore wind energy installations, especially in connection with risk management. This makes a transparent technology essential, which is reproducible metrologically.

Since conventional wind energy installations and their components are dimensioned very large, two glaring disadvantages, which lead to uneconomic down times of the wind energy installations, are brought to light in the event of any damage. First of all, components of this size are manufactured only after an order has been placed (with manufacturing lead times for raw materials, such as forged rings), delivery times of up to six months for components of this size being customary. Secondly, the complete nacelle of the wind energy installation, including a rotor, must be dismantled. In the case of onshore wind energy installations, this is a quantity, which can be calculated at least partly. However, in the case of offshore wind energy installations, the question of wind and waves arises in addition to the problem of the availability and costs (EUR 50,000/day) of heavy-load ships' cranes.

### SUMMARY OF THE INVENTION

In comparison to the preceding, the inventive nacelle for a wind energy installation has the advantage that, due to a wave-shaped basic frame, which is connected with a revolving connection, point loads arise at the connecting points, which can be dissipated optimally.

According to an advantageous development of the inventive nacelle, the basic frame is sinusoidal.

According to an additional advantageous configuration of the inventive nacelle, the basic frame is divided into segments. As a result, the parts of the basic frame can be exchanged individually.

According to an additional advantageous configuration of the inventive nacelle, the supporting construction of the inventive nacelle is formed from a truss construction. The tensile and compressive forces that occur are passed on optimally by the truss joints connecting the rods.

According to an additional configuration of the inventive nacelle, which is advantageous in this respect, the truss construction is self-supporting. By these means, the load-bearing capacity is increased, whereas the specific weight is lower.

According to an additional configuration of the inventive nacelle, which is advantageous in this respect, the truss construction is covered at least partly with an external skin. By these means, the truss construction is adapted individually to the requirements of design and technique.

Compared to the prior art, the inventive revolving connection for a wind energy installation according to an embodiment of the invention has the advantage that this bearing-forming means has at least one roll. A revolving connection, which is easily monitored and cost effective, is created by this standard component.

According to an advantageous configuration of the inventive revolving connection, the roll is held at the part on the nacelle side and/or at the part on the tower side. Accordingly, the part at the nacelle side, at which the nacelle is disposed, is supported over the roll on the part at the tower side and/or is supported on the roll disposed at the part at the tower side.

According to an additional advantageous configuration of the inventive revolving connection, the roll is a standard, heavy load roll, which is comparable with a railroad roll.

According to an additional, advantageous configuration of the inventive revolving connection, the part on the nacelle side and/or the tower side is divided into segments, which can be exchanged individually.

According to an additional advantageous configuration of the inventive revolving connection, the part on the nacelle side and/or the tower side is constructed at least partly as a race.

According to an additional, advantageous configuration of the inventive revolving connection, the part on the nacelle side is constructed as a frame.

According to an additional, advantageous configuration of the inventive revolving connection, a tooth system is disposed at the nacelle side coaxially with the part on the nacelle side. At least one pinion, driven by a motor, engages the tooth system, rotating the wind direction tracking system. What is termed an involute serration (referred to commonly as “gear wheels”) is regarded as the conventional technology for the tooth system. However, the inventive revolving connection can be operated with any type of tooth system.

According to a configuration of the inventive revolving connection, which is advantageous in this regard, the tooth system is a rack and pinion gearing. The rack and pinion gearing is a simple form of the tooth system, which reflects a long technological tradition and is used when accuracy requirements are low (for example, weirs for storage dams). Because of a prevailing wind direction, the rack and pinion gearing in the wind energy installation shows wear in only a limited region. Advantageously, therefore, the rack and pinion gearing consists of stave bolts, which can be exchanged individually.

According to an additional, advantageous configuration of the inventive revolving connection, there is an accommodating element at the part on the nacelle side for accommodating an accommodating frame for a kingpin, the accommodating frame being disposed coaxially with the part on the nacelle side.

According to an additional advantageous configuration of the inventive revolving connection, the accommodating frame is suspended cardanically at the accommodating element.

According to an additional, advantageous configuration of the inventive revolving connection, the kingpin is suspended cardanically at the accommodating frame.

According to an additional advantageous configuration of the inventive revolving connection, at least one load sensor is disposed at the kingpin for stress analyses. The kingpin, which has also already been used for German windmills or war mounts, serves to accommodate forces acting in the horizontal direction. Loads, occurring at the kingpin during the operation, are measured continuously by the load sensor. By these means, the fatigue of the component is monitored, so that the kingpin, which usually is a simple part, which can be produced on a lathe, can be exchanged in good time.

According to a configuration of the inventive revolving connection, which is advantageous in this regard, the load sensor is a strain gauge.

According to an additional advantageous configuration of the inventive revolving connection, at least one securing means is provided, by means of which the nacelle is prevented from lifting off.

According to a configuration of the inventive revolving connection, which is advantageous in this regard, the securing means is a redundant lifting-off safeguard. By means of this additional expense, which is actually not absolutely essential in the inventive revolving connection, the reliability of the inventive revolving connection is increased.

According to a configuration of the inventive revolving connection, which is advantageous in this regard, the securing means are disposed at the part on the tower side.

According to an additional advantageous configuration of the inventive revolving connection, the securing means are integrated in the kingpin.

Compared to the prior art, the inventive wind energy installation according to another embodiment of the invention has the advantage that it is put together predominately from standard components (structural steel, standard purchased parts, simple turned components, etc.), which are easily monitored and are cost effective.

According to an advantageous configuration of the inventive wind energy installation, components, required for the operation, can be produced easily and/or can be exchanged easily.

According to an additional advantageous configuration of the inventive wind energy installation, at lease one part of the components, made from steel, is produced from steel for ship construction. Among experts, steel for ship construction is referred to as “good-natured”, that is, it is a very conservative material with regard to the strengths reserves and resistance to hydrogen embrittlement, a phenomenon, which occurs massively in a saline environment.

According to an additional, advantageous configuration of the inventive wind energy installation, possible storage sites for spare parts are provided in the inventive wind energy installation. Accordingly, rapid access to a necessary replacement part is ensured for exchanging a component. Preferably, the possibility of storing replacement parts (replacement wheels, etc.) is provided in the nacelle. As a result, access is accelerated once again and the repair-related downtimes are minimized drastically.

According to an additional advantageous configuration of the inventive wind energy installation, at least one crane (mobile, permanently installed), which may be a conventional, commercial rope winch, may be provided in the inventive wind energy installation.

According to an additional advantageous configuration of the inventive wind energy installation, at least one overnighting possibility is provided in the inventive wind energy installation. Aside from accommodating, for example, service personnel overnight, it is entirely conceivable that the overnighting facilities may be utilized for emergency rescues at sea or fitted out as a hotel for adventure vacations. The equipment (beds, plumbing facilities etc.) of the overnighting facilities is variable and adapted to the intended use.

According to an additional advantageous configuration of the inventive wind energy installation, a helicopter platform is provided at the wind energy installation. By these means, spare parts may be delivered, for example, by sea as well as by air. Preferably, the helicopter platform is provided at the nacelle.

Compared to the prior art, the inventive method of operating a wind energy installation has the advantage that elementary components, which are required for the operation, can be exchanged and/or manufactured anywhere easily and independently of the type of wind energy installation, so that downtimes are minimized. As a result, the technical availability of the inventive wind energy installation is increased and the earnings are optimized.

According to an additional, advantageous configuration of the inventive method, a component is exchanged before a functional breakdown sets in (preventive maintenance).

Further advantages and advantageous configurations of the invention may be inferred from the following description, the drawing and the claims.

Examples of the object of the invention are explained in greater detail in the following and shown in the drawing.

### BRIEF DESCRIPTION OF THE DRAWINGS

FIG. 1 shows an isometric view of a truss construction of an inventive nacelle;

FIG. 2 shows a main view of a truss construction of an inventive nacelle;

FIG. 3 shows a plan view of a truss construction of an inventive nacelle;

FIG. 4 shows detailed views of a truss construction of an inventive nacelle;

FIG. 5 shows a side view of a truss construction of an inventive nacelle;

FIG. 6 shows an isometric view of a wave-shaped basic frame of an inventive nacelle;

FIG. 7 shows a main view of a wave-shaped basic frame of an inventive nacelle;

FIG. 8 shows a plan view of a wave-shaped basic frame of an inventive nacelle;

FIG. 9 shows an isometric view of an inventive nacelle disposed at an inventive revolving connection;

FIG. 10 shows a main view of an inventive nacelle disposed at an inventive revolving connection;

FIG. 11 shows a side view of an inventive nacelle disposed at an inventive revolving connection;

FIG. 12 shows a plan view of an inventive nacelle disposed at an inventive revolving connection;

FIG. 13 shows a plan view of an inventive revolving connection;

FIG. 14 shows a main view of an inventive revolving connection;

FIG. 15 shows a side view of an inventive revolving connection;

FIG. 16 shows a detailed view of an inventive revolving connection; and

FIG. 17 shows an isometric view in an exploded representation of an inventive revolving connection.

### DETAILED DESCRIPTION OF THE INVENTION

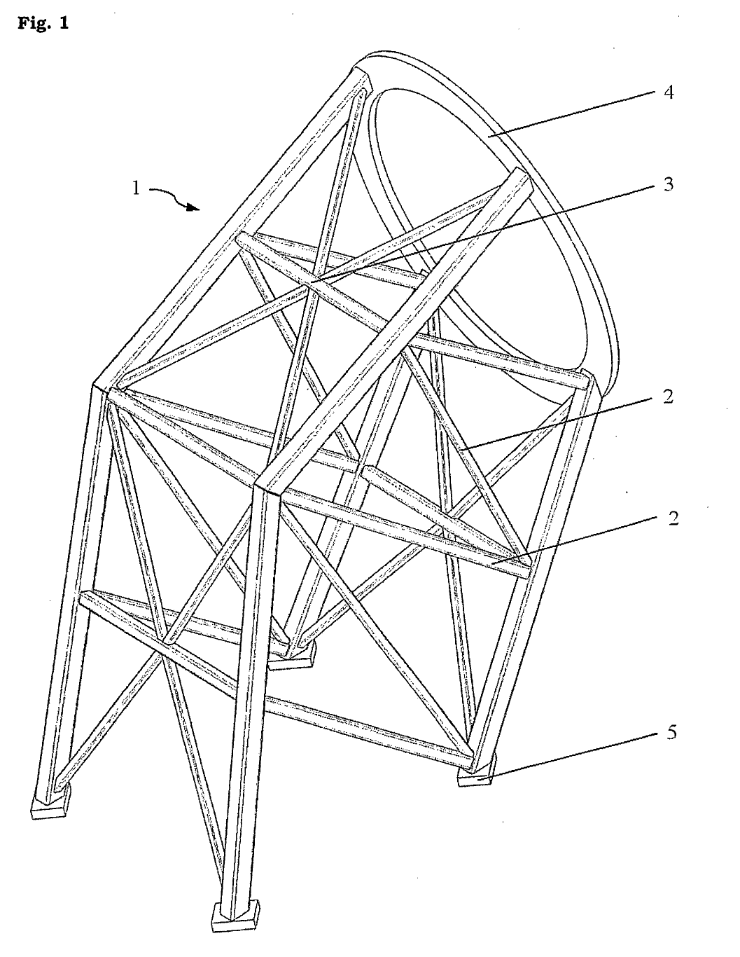

FIG. 1 shows an isometric view of a truss construction of an inventive nacelle 1. This comprises rods 2, which form joints 3 at their points of intersection. The termination in the direction of a rotor hub, which is not shown, is formed by a ring 4. On the side, averted from the ring 4, vertical load distribution takes place over the connecting points 5 on the nacelle side. The advantage of the truss construction consists therein that, because of its variability, it offers a plurality of possibilities for the configuration of the inventive nacelle 1 and modular additions (comparable with known approaches employing the “Fischer technique” are also possible without problems.

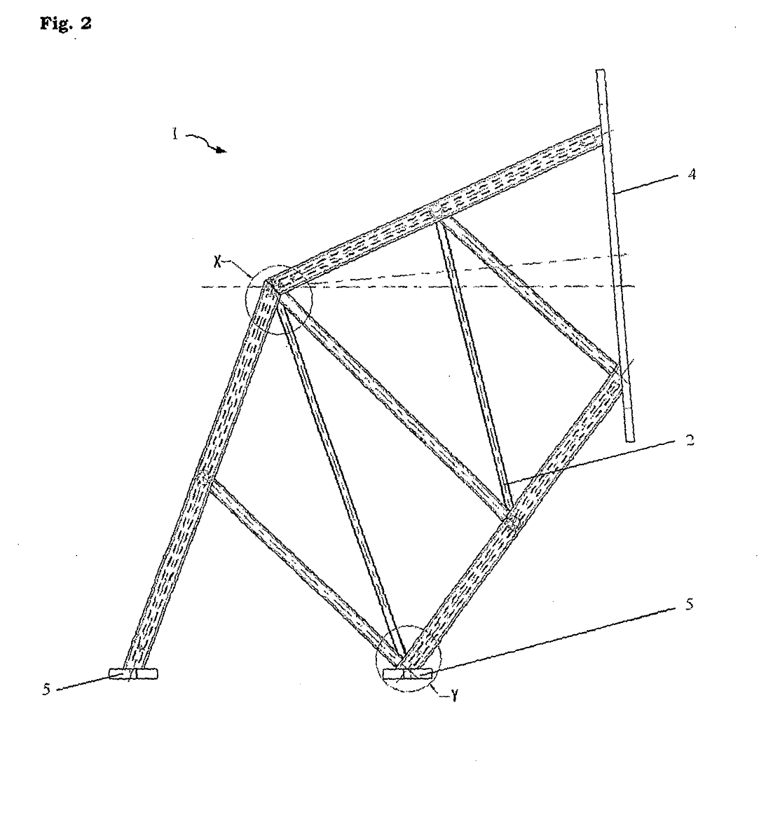

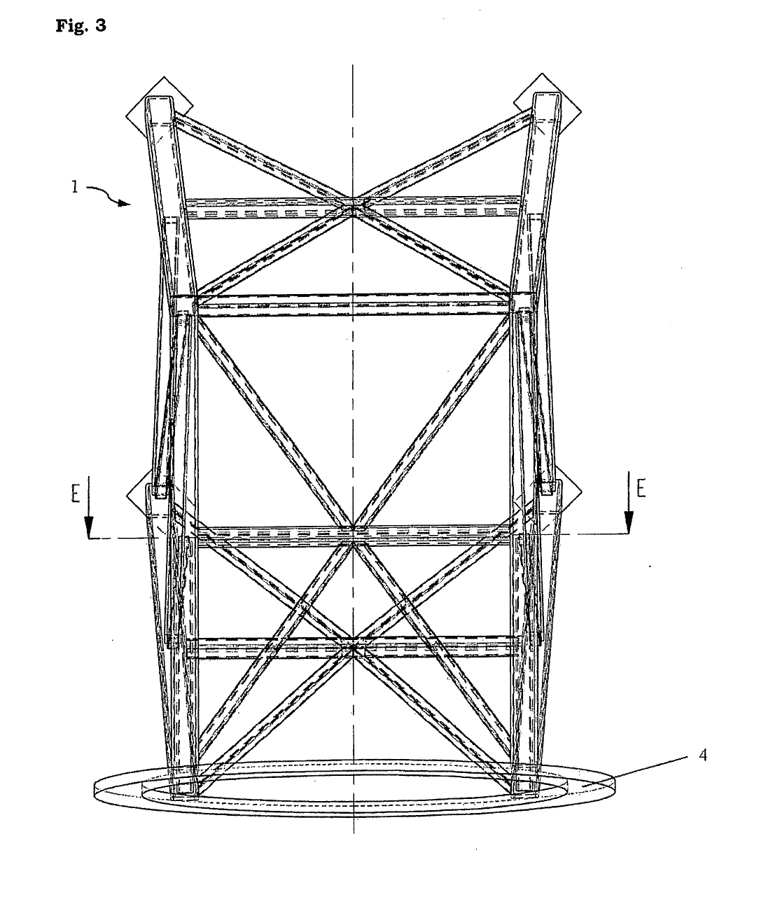

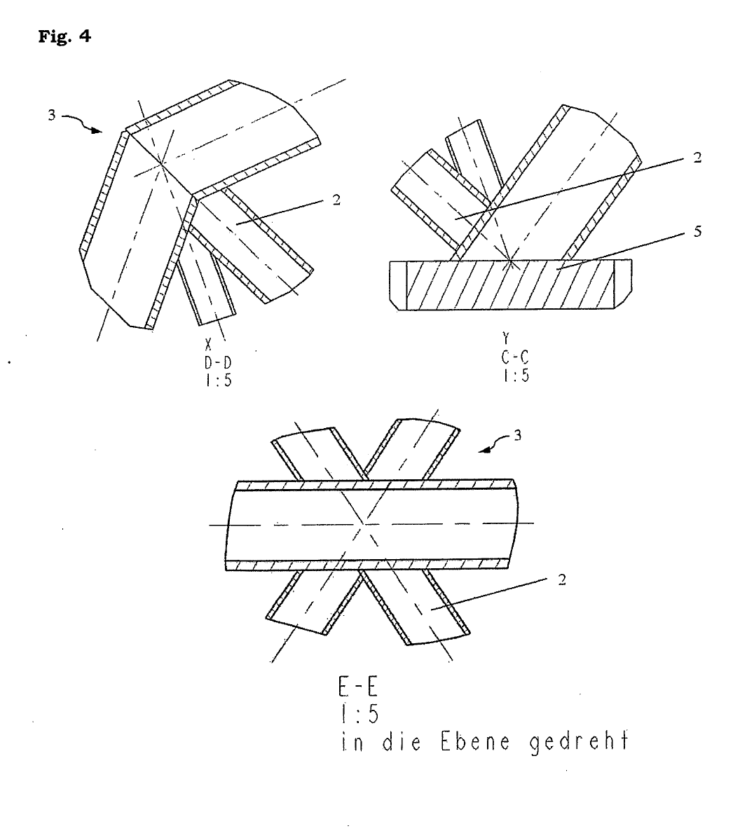

FIGS. 2 and 3 show a main view and a plan view of a truss construction of an inventive nacelle 1. It becomes clear that the ring 4 need not necessarily be aligned vertically, but may be somewhat inclined (inclination of the axis of the rotor). The detailed views X and Y, as well as a section, rotated in the plane, are shown in FIG. 4.

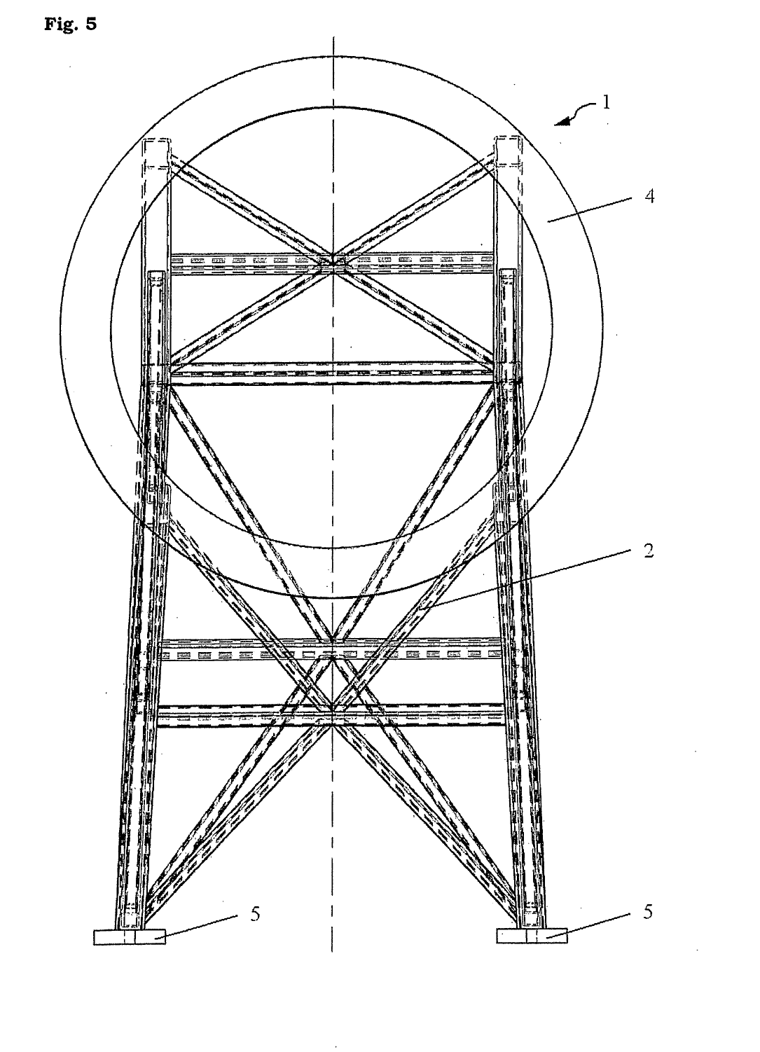

FIG. 5 shows a side view of a truss construction of a nacelle 11 according to the invention.

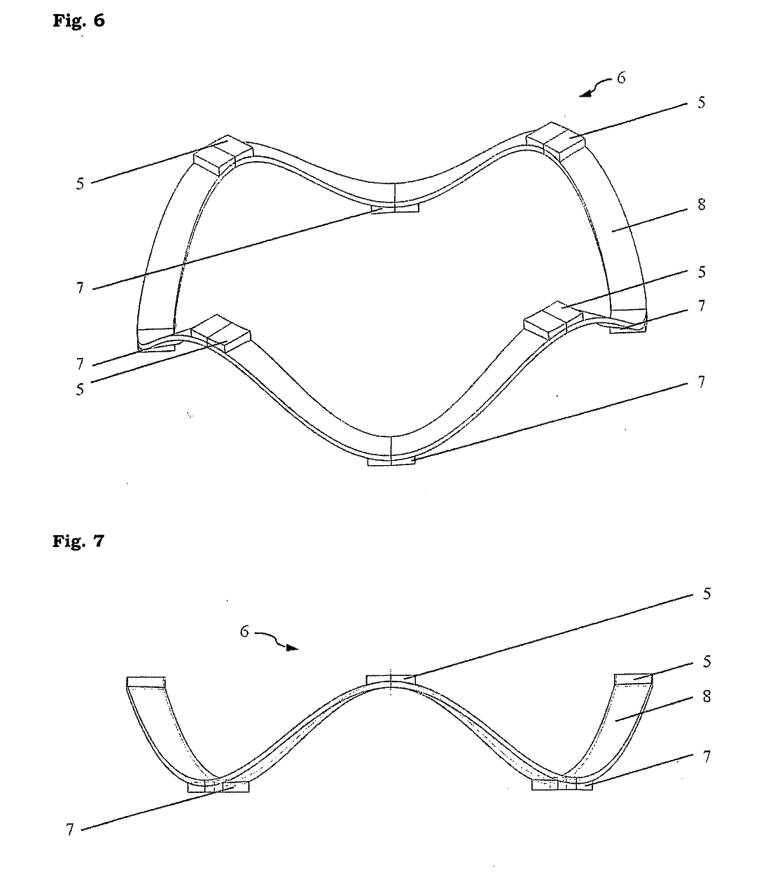

FIG. 6 shows an isometric view of a basic frame 6 of a nacelle according to the invention. The basic frame is wave-shaped and connected over the connecting points 5 at the nacelle side with the truss construction. Over connecting points 7 at the tower side, the basic frame 6 is connected with the revolving connection, which is not shown here. It is clear here that the basic frame 6 is assembled from several segments 8.

FIG. 7 shows a main view of a wave-shaped basic frame of a nacelle according to the invention.

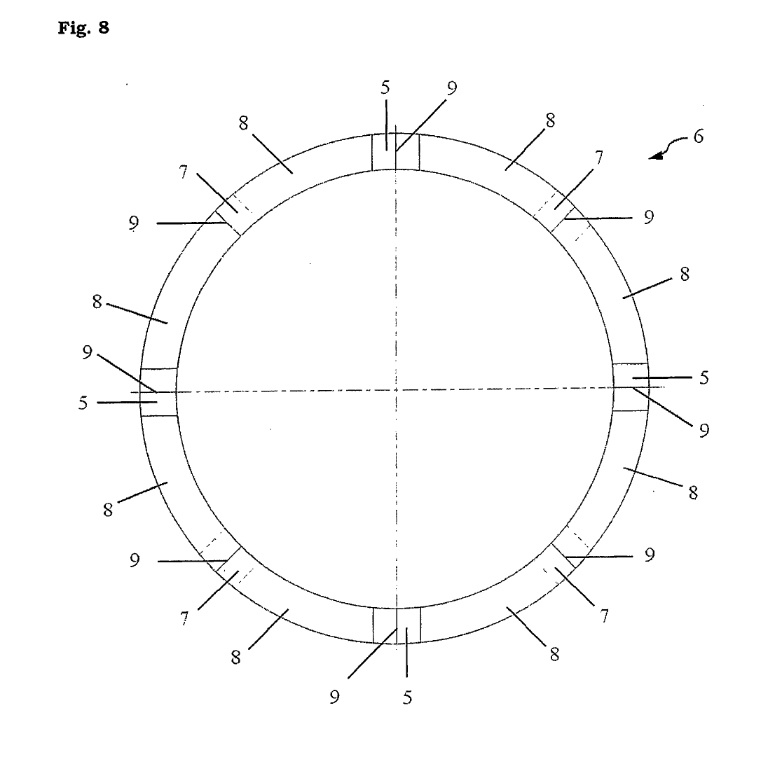

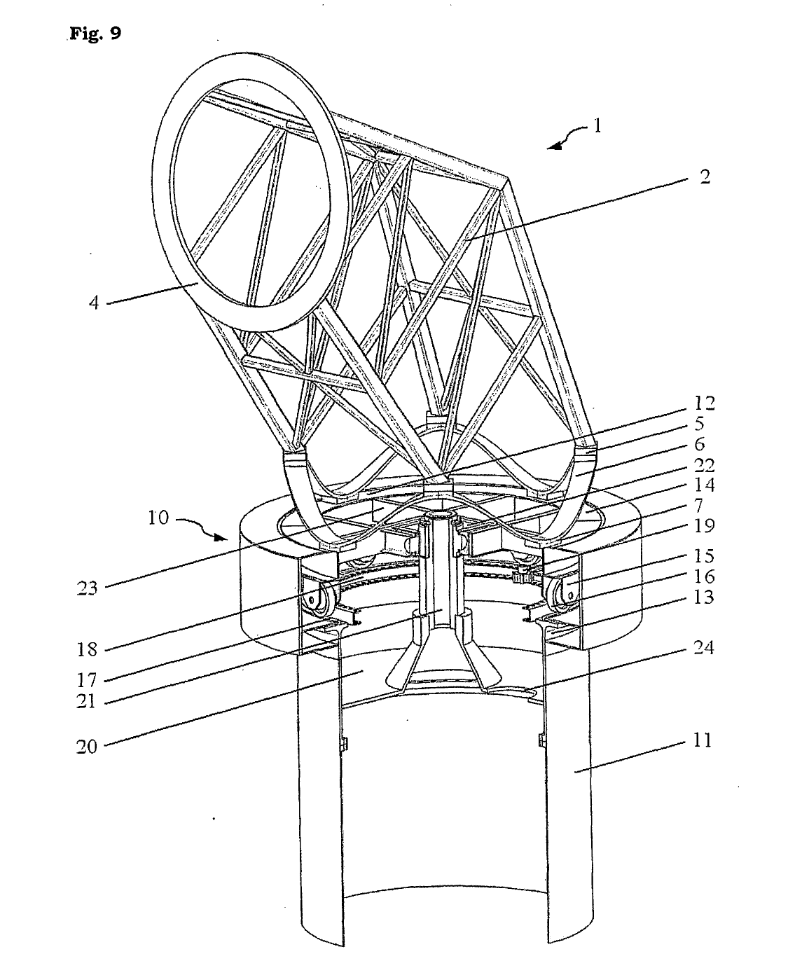

FIG. 8 shows a plan view of a wave-shaped basic frame of a nacelle according to the invention. It is clear here that the contact points 9 of the segments 8 in the present case are disposed above the connecting points 7 on the tower side and below the connecting points 5 at the nacelle side. By dividing the basic frame 6 into individual segments 8, it is possible to exchange individual segments 8, which have, for example, become defective, without having to lift off the inventive nacelle completely.

FIG. 9 shows an isometric view of a nacelle 1 according to the invention, which is disposed over the connecting points 7 at the tower side at an inventive revolving connection 10. The inventive revolving connection 10 is supported on the tower 11 and enables the inventive nacelle 1 on the tower 11 to be rotated about the vertical axis of the tower. The inventive revolving connection 10 consists of a part 12 on the nacelle side, which is configured as a frame 14, and a part 13 on the tower side. Fastening devices 15, at which rolls 16, which may, for example, be conventional, standard, heavy duty rolls, are disposed easily exchangeably as bearing-forming means, are mounted at the part 12 on the nacelle side. The part 13 at the tower side advantageously is constructed as a race 17. In addition, a rack and pinion gearing 18 is mounted at the part 13 on in the tower side. By means of this rack and pinion gearing 18 and at least one pinion 19, which can be driven by a driving mechanism that is not shown an active wind tracking system of the inventive nacelle 1, which may also be constructed so that it can be braked, becomes possible. For reasons of clarity, the standard steel pins of the rack and pinion gearing 18 are not shown. Coaxially with the individual components of the inventive revolving connection 10, which preferably are constructed, for example, by subdividing them in such a manner that they can be exchanged easily, there is a kingpin 21, which absorbs tensile forces, represents an easily produced turned part, is fixed at the tower 11 by a fastening device 20 and passes loads into the tower. The king pin 21 is suspended cardanically at an accommodating frame 22, which in turn is disposed cardanically at an accommodating element 23, which is connected with the part 12 at the nacelle side. It is possible to walk on the revolving connection 10 over an inspection hole 24.

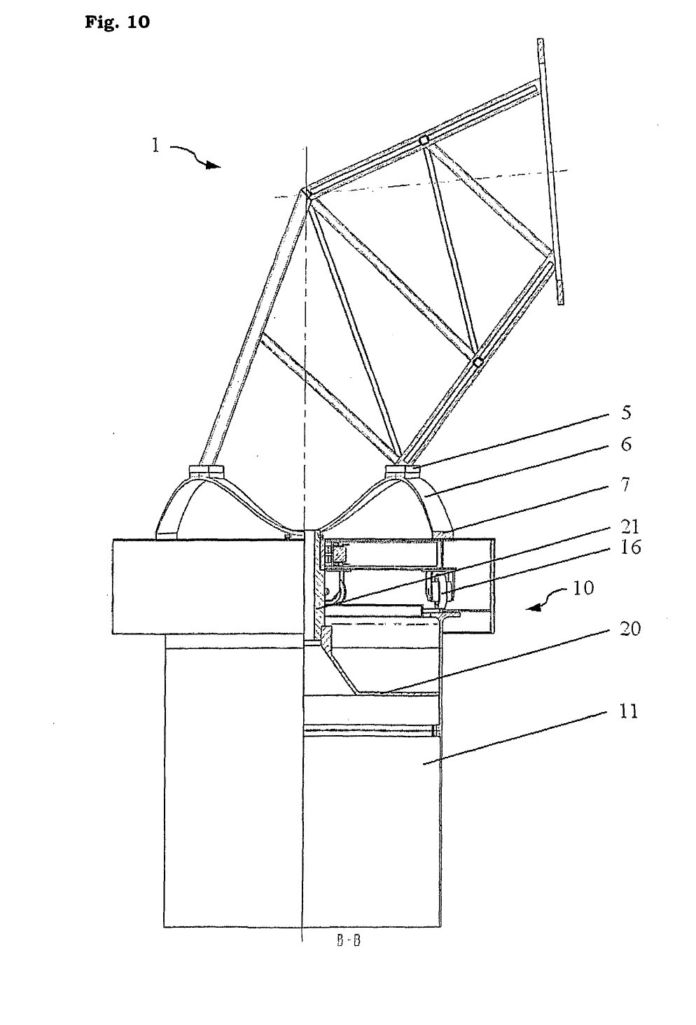

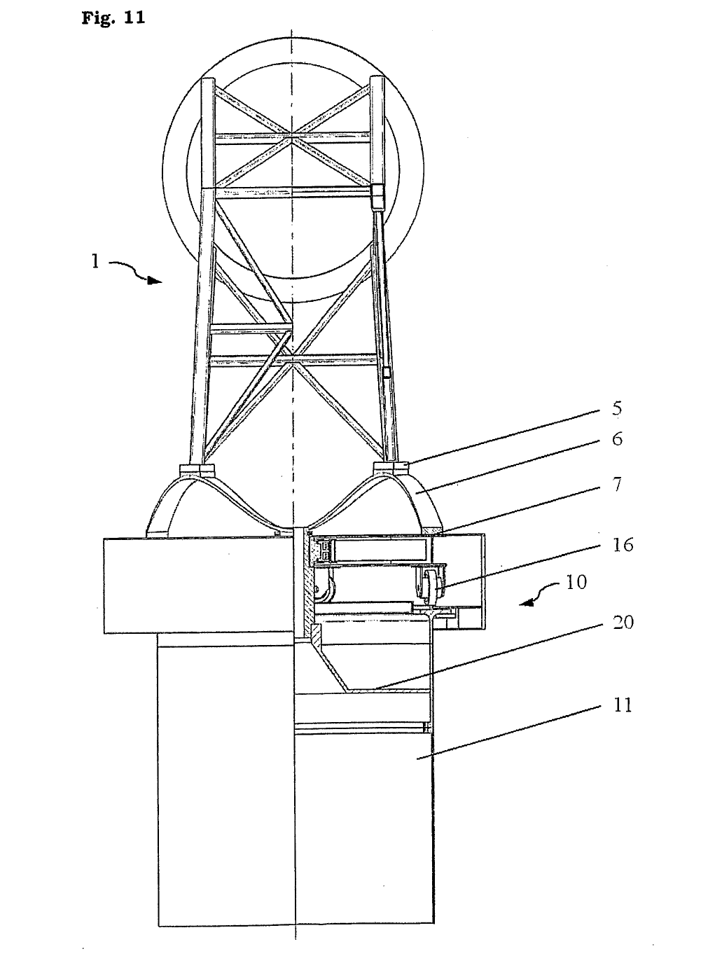

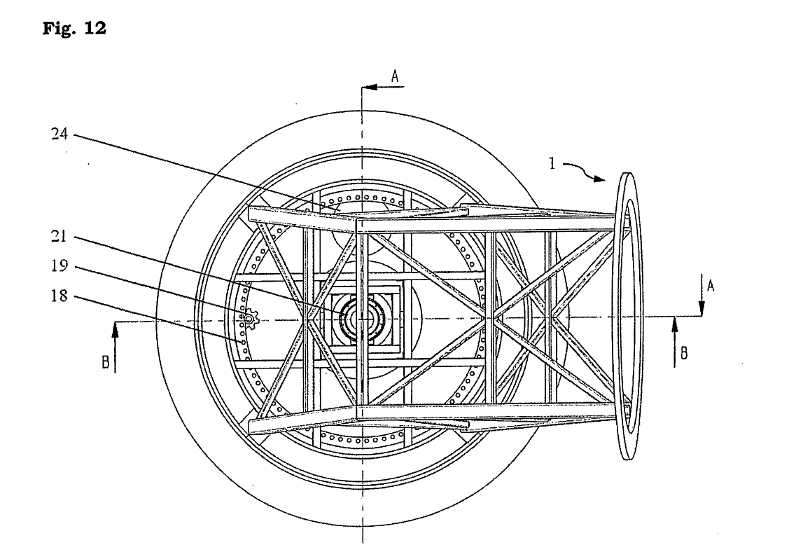

To illustrate reconstruction, a main view, a side view and a plan view of the inventive nacelle 1, disposed at an inventive revolving connection 10, is shown in FIGS. 10 to 12.

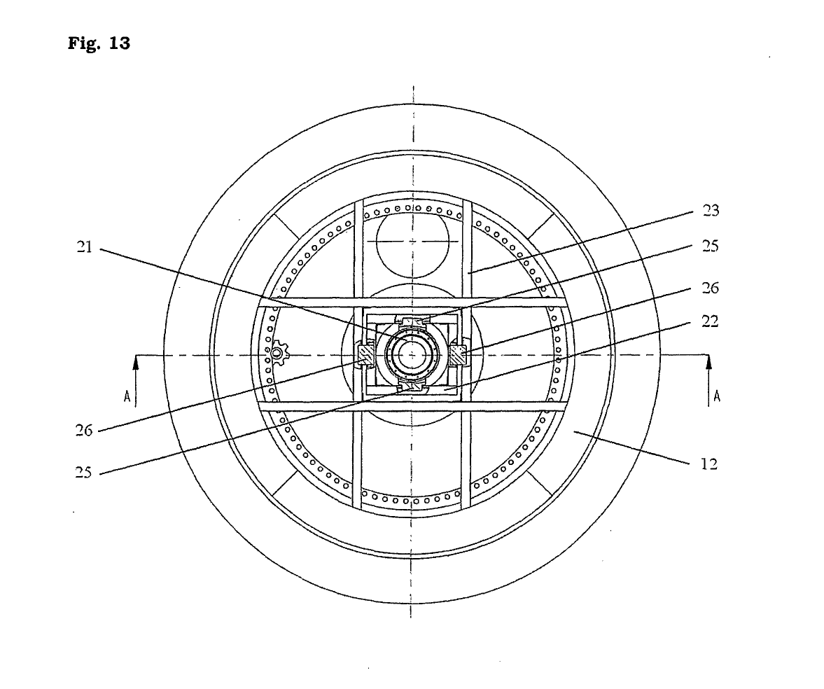

FIG. 13 shows a plan view of an inventive revolving connection 10. It becomes clear here that the cardanic suspension 25 of the kingpin 21 at the accommodating frame 22 and the cardanic suspension 26 of the accommodating frame 22 at the accommodating element 23 are offset by 90.

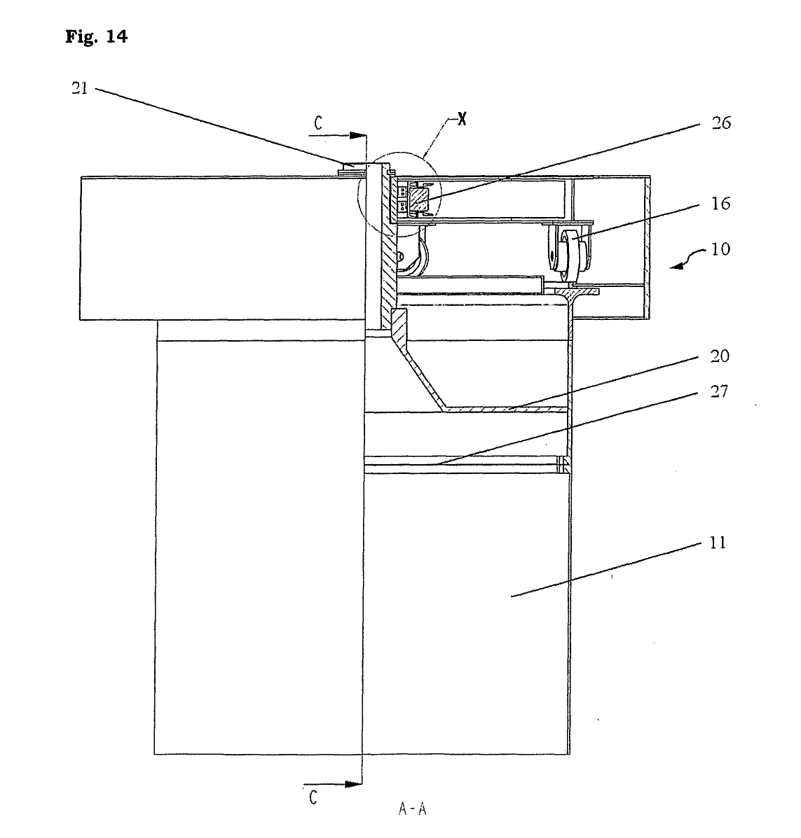

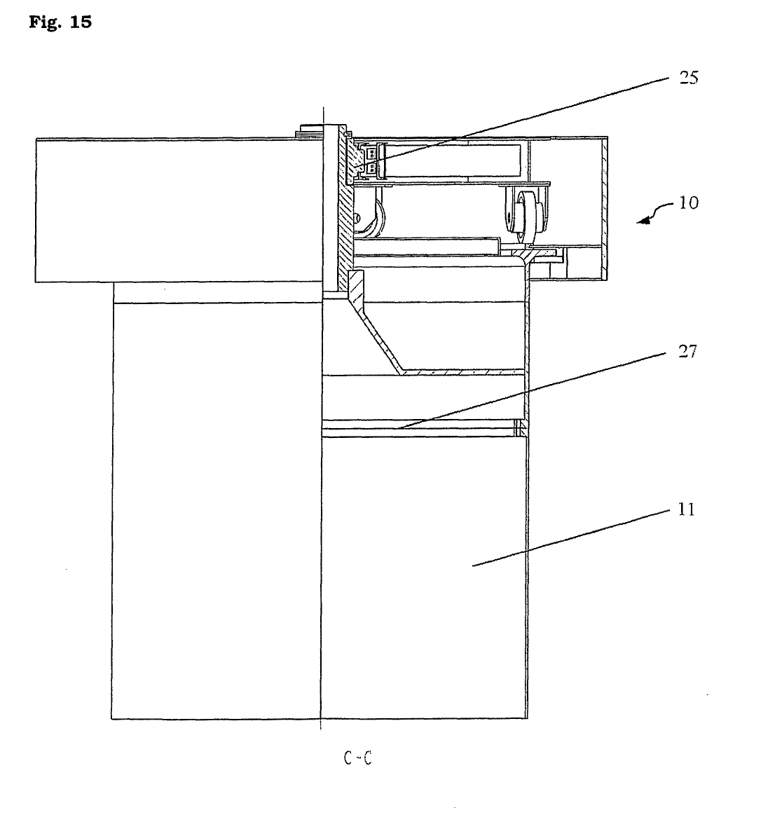

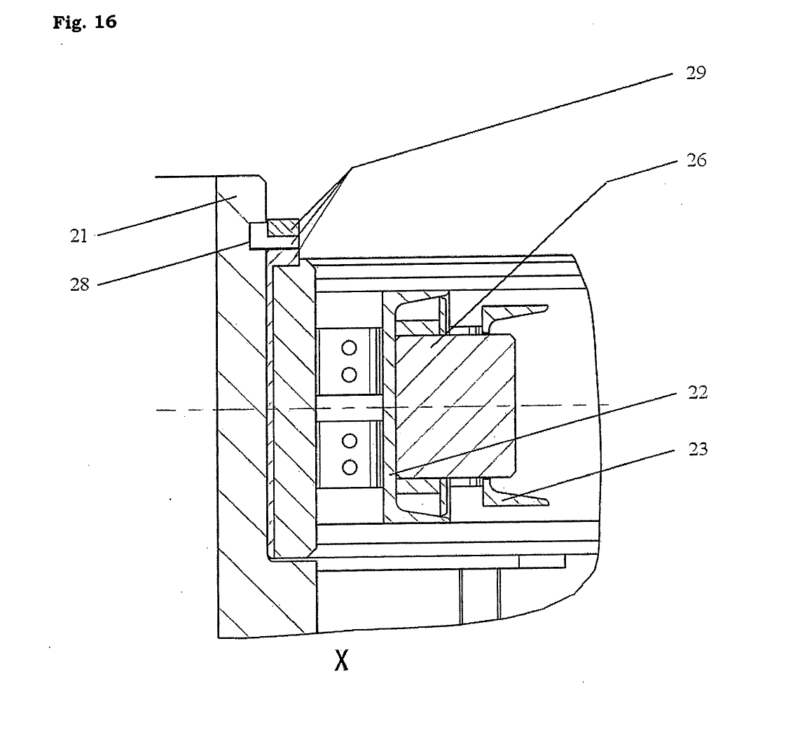

FIGS. 14 and 15 show a main view and a side view of the inventive revolving connection 10, which can be placed over a flange connection 27 on a conventional tower 11. The detail X, marked in FIG. 14, is shown on a larger scale in FIG. 16. In order to prevent the inventive nacelle 1 lifting off, the kingpin 21 has a groove 28, into which a lifting-off safeguard 29, which preferably consists of a divided ring, is brought. By these means, the accommodating frame 22 is prevented from slipping upward from the king pin 21. In addition, the cardanic suspension 26 of the accommodating frame 22 at the accommodating element 23 becomes clear.

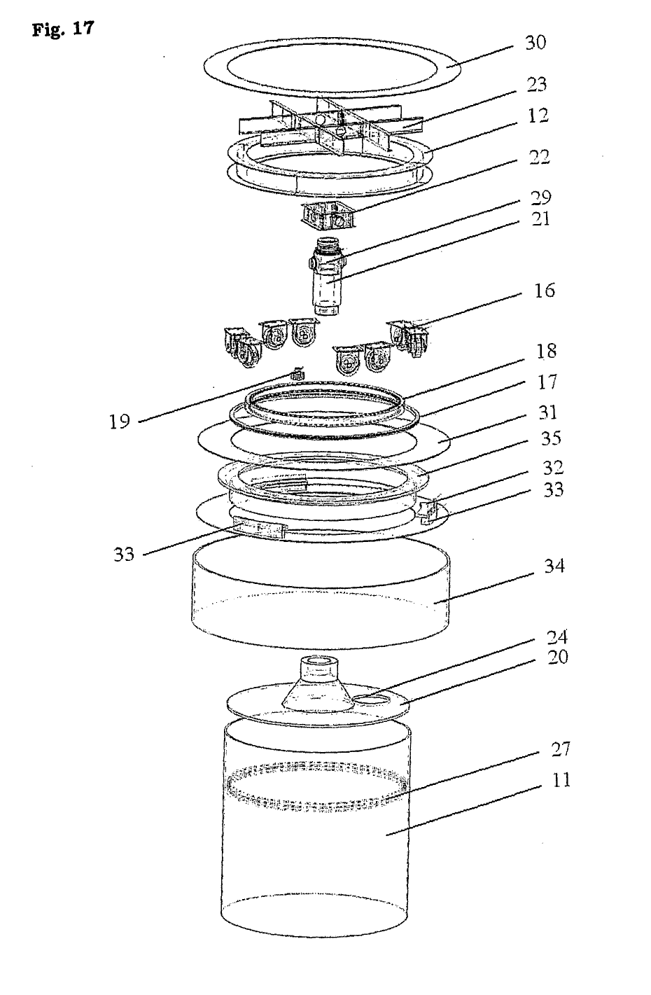

FIG. 17 shows an isometric view in an exploded representation of an inventive revolving connection 10, which is closed off towards the top by a terminating metal sheet 30. In addition, it becomes clear that the race 17 is accommodated by an annular centering 31 and that lifting off of the inventive nacelle 1 is prevented by an additional, redundant lifting-off safeguard 32, which is accommodated in a receptacle 33 and engages a counterpart 35. There is an outer sheath 34 to protect the inventive revolving connection 10 towards the outside.

It can be seen from the drawing that the construction of an inventive wind energy installation may comprise a tower 11, an inventive revolving connection 10 and an inventive nacelle 1. Likewise, it is conceivable that, because of compatible connecting sites (such as the flange connection 27) with an appropriate configuration of the inventive components, the construction of the inventive wind energy installation may comprise a tower 11, a conventional revolving connection (such as a ball bearing revolving connection) and an inventive nacelle 1 or of a tower 11, an inventive revolving connection 10 and a conventional nacelle (such as a cast nacelle). The inventive components, which are distinguished by an advantageous decrease in load by rod and point loads, accordingly can be produced globally and used globally for all types of wind energy installation. A wind energy installation may be planned by a 3-D CAD model, which is distinguished by its parametric variability.

A high-quality, conventional, commercial 3-D CAD software permits an “intelligent model” to be produced, that is, a “geometric programming” of components and assemblies. There are also special software packages for the conversion of 3-D CAD geometries between the individual systems.

The intelligence, which is programmed into a product, is the sole know-how of the inventor. In the present proposal, many years of mechanical engineering and wind energy know-how from development and plant management are combined with knowledge and experience of the high-and use of high quality 3-D CAD and FEM (finite element method) software. Both find use in an intelligent, programmed 3-D CAD data record.

The use of the present proposal by the customer consists of making the know-how, developed in intelligently constructed designs, directly useful for the products of the customer. All engineering knowledge and associated tests on virtual prototype are programmed into the design. The only task for the development team of the customer consists of adapting the “blank” (that is, the acquired rights to the use of the 3-D CAD data record and the data record itself), which advantageously can be carried out by a single engineering service, to the main component of the wind energy installation. Detailed tests by means of the customer-specific virtual prototypes, so produced (that is, of the 3-D assembly in the 3-D CAD, equipped with the components of the customer), have already been employed within the “blank” and, knowing the operation of the software, can be carried out directly by the customer.

Since the inventive revolving connection 10 and/or the inventive nacelle 1 have components, which can be produced and/or exchanged easily, these components may, for example, be replaced cost effectively within fixed exchange interval, in order to minimize downtimes of the inventive wind energy installation.

All distinguishing features, shown here, may be essential to the invention individually as well as in any combination with one another.

### LIST OF REFERENCE NUMBERS

1. nacelle
2. rod
3. joint
4. ring
5. connecting point at the nacelle side
6. basic frame
7. connecting point at the tower side
8. segment
9. contact
10. revolving connection
11. tower
12. part on the nacelle side
13. part on the lower
14. frame
15. fastening devise
16. roll
17. race
18. rack and pinion gearing (shown without pins)
19. pinion
20. fastening device
21. kingpin
22. accommodating frame
23. accommodating element
24. inspection hole
25. cardanic suspension
26. cardanic suspension
27. flange connection
28. groove
29. lifting-off safeguard (kingpin)
30. terminating metal sheet
31. centering
32. redundant lifting-off safeguard (tower)
33. receptacle
34. outer sheath
35. counter piece (lifting-off safeguard)

1-32. (canceled)

33. A nacelle for a wind energy installation, comprising:
a load-bearing construction;
a ring for receiving a rotor;
a revolving connection; and
a basic frame for connecting the nacelle rotatably with a tower via said revolving connection, said basic frame presenting a wave shape.

34. The nacelle according to claim 33, wherein the wave shape of the basic frame is sinusoidal.

35. The nacelle according to claim 33, wherein the basic frame is divided into segments.

36. The nacelle according to claim 33, wherein the load-bearing construction of the nacelle is formed by a truss construction.

37. The nacelle according to claim 36, wherein the truss construction is self-supporting.

38. The nacelle according to claim 36, wherein the truss construction is covered at least partly with an external skin.

39. A revolving connection for a wind energy installation for rotating an essentially vertically nacelle which is supported by a tower, comprising:
a rotatable part on a nacelle side;
a part on a tower side which cannot be rotated and which is disposed coaxially with the rotatable part on the nacelle side; and
at least one bearing-forming structure being disposed between the rotatable part on the nacelle side and the part on the tower side, the structure forming the bearing including at least one roll.

40. The revolving connection according to claim 39, wherein the roll is held at the rotatable part at the nacelle side and/or at the part at the tower side.

41. The revolving connection according to claim 39, wherein the roll is a standard, heavy duty roll.

42. The revolving connection according to claim 39, wherein at least one of the rotatable part on the nacelle side or the part on the tower side is divided into segments.

43. The revolving connection according to claim 39, wherein at least one of the rotatable part at the nacelle side or the part at the tower side is constructed at least partly as a race.

44. The revolving connection according to claim 39, wherein the rotatable part at the nacelle side is constructed as a frame.

45. The revolving connection according to claim 39, further comprising a tooth system which is coaxial with the rotatable part at the nacelle side, said tooth system being disposed at the rotatable part at the nacelle side.

46. The revolving connection according to claim 45, wherein the tooth system includes a rack and pinion gearing.

47. The revolving connection according to claim 39, further comprising an accommodating element at the rotatable part at the nacelle side for accommodating an accommodating frame for a king pin, said accommodating element being disposed coaxially with the rotatable part at the nacelle side.

48. The revolving connection according to claim 47, wherein the accommodating frame is suspended cardanically at the accommodating element.

49. The revolving connection according to claim 47, wherein the kingpin is suspended cardanically at the accommodating frame.

50. The revolving connection according to claim 47, further comprising at least one load sensor being disposed at the kingpin for a stress analysis.

51. The revolving connection according to claim 50, wherein the load sensor includes a strain gauge.

52. The revolving connection according to claim 39, further comprising at least one securing structure for preventing the nacelle from lifting off.

53. The revolving connection according to claim 52, wherein the securing structure includes a redundant lifting-off safeguard.

54. The revolving connection according to claim 52, wherein the securing structure is disposed at the part on the tower side.

55. The revolving connection according to claim 52, wherein the securing means is disposed at the kingpin.

56. A wind energy installation, wherein the wind energy installation includes a nacelle according to claim 33.

57. The wind energy installation according to claim 56, wherein components required for operation are at least one of easily produceable or exchangeable.

58. The wind energy installation according to claim 56, wherein at least one part of the components which is made from steel, are made from a steel of a type for ship construction.

59. The wind energy installation according to claim 56, wherein storage possibilities for spare parts are provided in the wind energy installation.

60. The wind energy installation according claim 56, further comprising at least one crane.

61. The wind energy installation according to claim 56, further comprising at least one possibility for overnighting.

62. The wind energy installation according to claim 56, further comprising a helicopter platform.

63. A method for operating a wind energy installation according to claim 56, wherein components, basically required for the operation, are at least one of produceable or exchangeable easily, as a result of which, downtime is minimized.

64. The method according to claim 63, wherein a component is exchanged before a functional breakdown.

65. A wind energy installation, wherein the wind energy installation includes a revolving connection according to claim 39.

66. The wind energy installation according to claim 65, wherein components required for operation are at least one of easily produceable or exchangeable.

67. The wind energy installation according to claim 65, wherein at least one part of the components which is made from steel, are made from a steel of a type for ship construction.

68. The wind energy installation according to claim 65, wherein storage possibilities for spare parts are provided in the wind energy installation.

69. The wind energy installation according claim 65, further comprising at least one crane.

70. The wind energy installation according to claim 65, further comprising at least one possibility for overnighting.

71. The wind energy installation according to claim 65, further comprising a helicopter platform.
